(19) United States
(12) Patent Application Publication
(10) Pub. No.: US 2014/0152156 A1
(43) Pub. Date: Jun. 5, 2014

(54) POWER GENERATING APPARATUS

(71) Applicant: Chin-Ho CHIU, New Taipei City (TW)

(72) Inventor: Chin-Ho CHIU, New Taipei City (TW)

(21) Appl. No.: 14/097,764

(22) Filed: Dec. 5, 2013

(30) Foreign Application Priority Data
Dec. 5, 2012 (TW) 101223599

(51) Int. Cl. H02K 7/18

(52) U.S. Cl. CPC H02K 7/1807; H02K 53/00
USPC 310/75 D; 74/DIG. 9

(57) ABSTRACT

A power generating apparatus comprises a base, a rotary disk, a driving piece, a first energy gathering device and a pole. The rotary disk is pivotally connected to the base. The driving piece is connected to the rotary disk for controlling the rotary disk rotating. The first energy gathering device is disposed on the rotary disk. The pole is pivotally connected to the rotary disk, wherein a first heavy block is disposed at the end of the pole; an elastic piece is connected respectively to a front end of the pole and the first energy gathering device such that when the rotary disk rotates, the pole is kept vertically downwards and the elastic piece is stretched; while the pole moves with the rotary disk to a certain angle, the elastic piece is restored, so as to drive the first energy gathering device to gather energy.

### FIELD OF THE INVENTION

The present invention relates to power generating apparatus which is of a simple structure, easy to operate, and has low cost.

### BACKGROUND OF THE INVENTION

In recent years, facing the crisis that the energy on Earth is going to be exhausted, countries in the world continue to actively develop various methods for producing electrical power by using wind power, solar power, hydropower, and geothermal power in order to slow down the traditional energy consumption rate.

But the ways to generate energy by using wind power, solar power, hydropower, and geothermal power stated above are all subject to regional restriction. For example, in some area the wind power is weak all year round, and hence wind power may not be used as the source of generating power. Similarly, in some area the weather is rainy all year round, and hence solar power may not be used as the source of generating power. Besides, hydropower and geothermal power could be used only in the blessed areas having hydropower and geothermal power, and they may not be suitable for other areas in the world.

In view of these facts and in order to overcome the drawbacks stated above, the present invention provides a mechanically-type power generating apparatus.

### SUMMARY OF THE INVENTION

The main object of the present invention is to provide a power generating apparatus with simple structure, easy operation and low cost.

To achieve the main object stated above, the present invention discloses a power generating apparatus comprises a base, a rotary disk, a driving piece, a first energy gathering device and a pole. The rotary disk is pivotally connected to the base. The driving piece is connected to the rotary disk for controlling the rotary disk rotating. The first energy gathering device is disposed on the rotary disk. The pole is pivotally connected to the rotary disk, wherein an end of the pole is extended beyond the center of the rotary disk and a first heavy block is disposed at the end of the pole; an elastic piece is connected respectively to a front end of the pole and the first energy gathering device such that when the rotary disk rotates, the pole is kept vertically downwards because of gravity and the elastic piece is stretched because of the rotation of the rotary disk; while the pole moves with the rotary disk to a certain angle, the elastic piece is restored, so as to drive the first energy gathering device to operate to gather energy.

In an embodiment, the driving piece is a motor.

In an embodiment, the front end of the pole is provided with a motor and the elastic piece is connected respectively to the motor and the first energy gathering device.

In an embodiment, a second heavy block is disposed at an opposite end of the rotary disk with respect to the position to which the pole is connected.

In an embodiment, the elastic piece is a spring.

In an embodiment, a second energy gathering device is connected to the center of the rotary disk.

For further understanding the characteristics and effects of the present invention, some preferred embodiments accompanying attached drawings are in detail described as follows.

### BRIEF DESCRIPTION OF DRAWINGS

FIG. 1-4 are the schematic diagrams showing the states of operation for a power generating apparatus in an embodiment of the present invention.

FIG. 5 is a schematic diagram showing the state of operation of the power generating apparatus in another embodiment of the present invention.

### DETAILED DESCRIPTION OF PREFERRED EMBODIMENTS

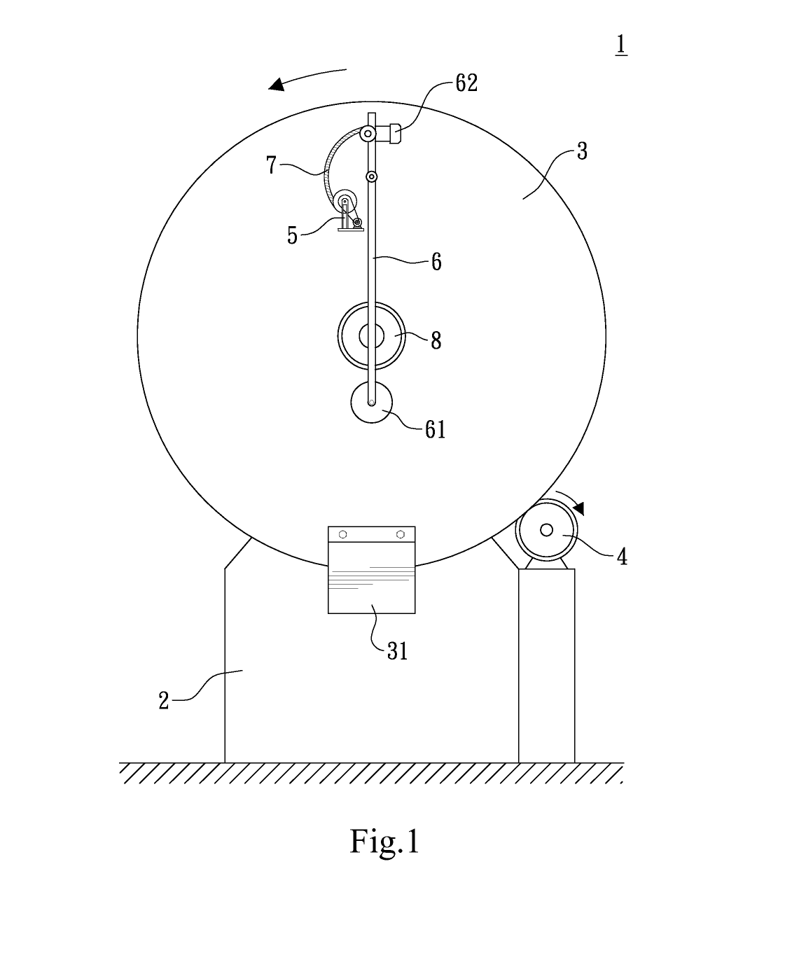

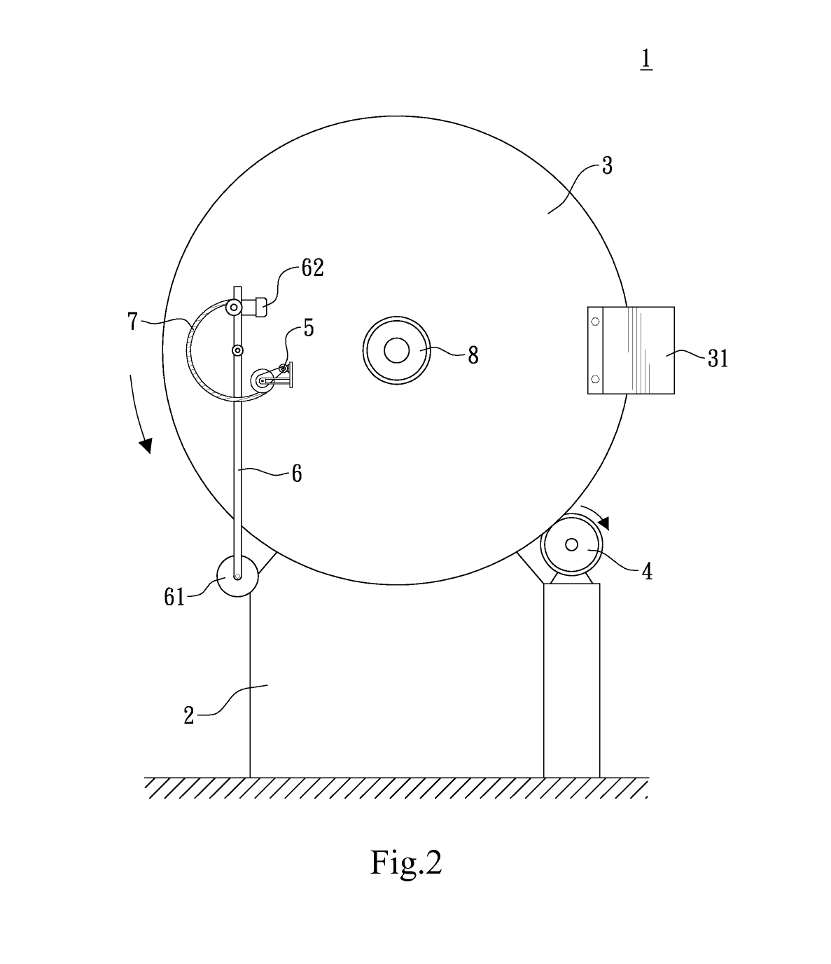

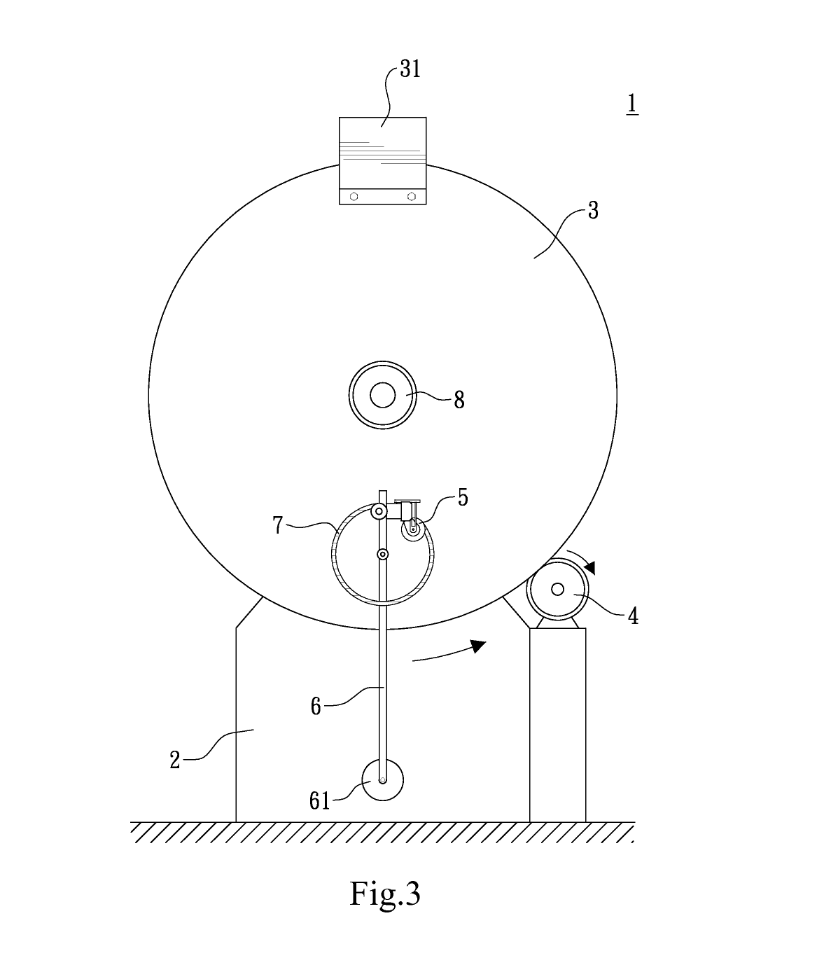

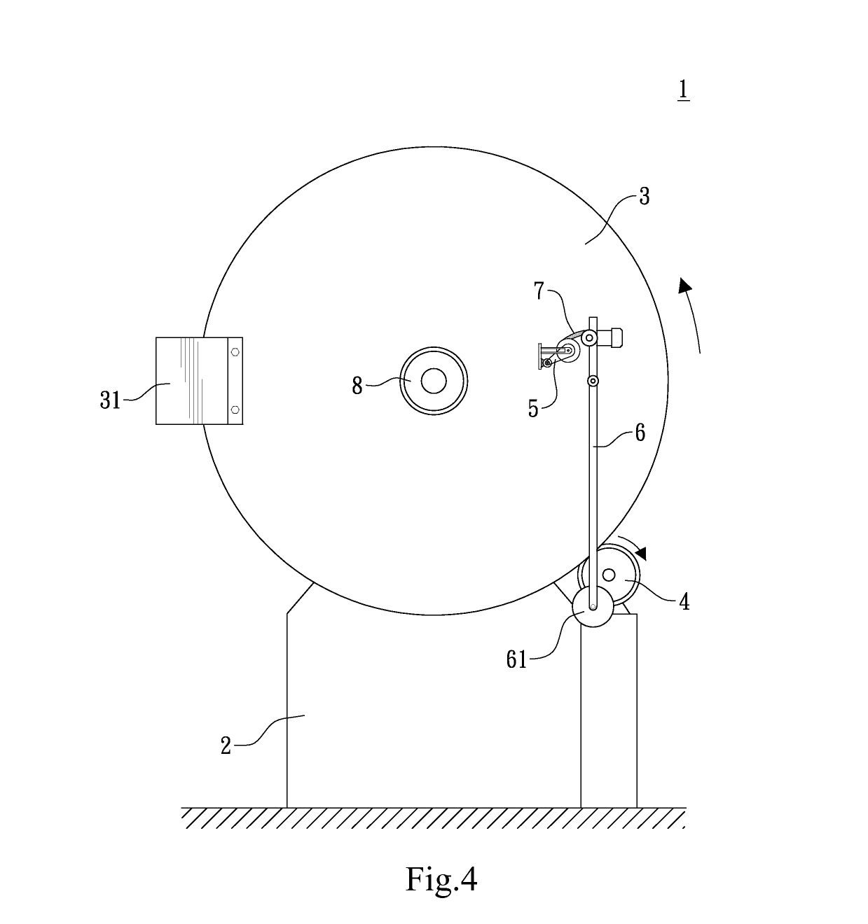

Please referring to FIG. 1-4, the schematic diagrams show an embodiment of the present invention. The power generating apparatus 1 comprises a base 2, a rotary disk 3, a driving piece 4, a first energy gathering device 5 and a pole 6.

The rotary disk 3 is pivotally connected to the base 2. The driving piece 4 is connected to the rotary disk 3 for controlling the rotary disk 3 rotating. The first energy gathering device 5 is disposed on the rotary disk 3. The pole 6 is pivotally connected to the rotary disk 3, wherein an end of the pole 6 is extended beyond the center of the rotary disk 3 and a first heavy block 61 is disposed at the end of the pole 6; an elastic piece 7 is connected respectively to the front end of the pole 6 and the first energy gathering device 5. In this embodiment, the driving piece 4 is a motor and the elastic piece 7 is a spring. The front end of the pole 6 is provided with a motor 62 and the elastic piece 7 is connected respectively to the motor 62 and the first energy gathering device 5. A second heavy block 31 is disposed at an opposite end of the rotary disk 3 with respect to the position where the pole 6 is connected to.

Hence, in the embodiment, as depicted in FIG. 1-4, it is first to drive the rotary disk 3 rotating by the driving piece 4 (i.e. a motor). When the rotary disk 3 rotates (Ex. in a counterclockwise direction), the pole 6 moves with the rotation of the rotary disk 3 from the position on the top of the rotary disk 3 to the position on the left-hand side of the rotary disk 3, such that the elastic piece 7 connected between the first energy gathering device 5 and the pole 6 is stretched. When the pole 6 moves with the rotation of the rotary disk 3 to the position on the bottom of the rotary disk 3, the elastic piece 7 is stretched to the most extent. While the pole 6 moves with the rotation of the rotary disk 3 to the top of the rotary disk 3, the elastic piece 7 is restored immediately, so as to drive the first energy gathering device 5 to operate to gather energy.

Similarly, when the rotary disk 3 continues rotating, the elastic piece 7 is repeating the stretched and the restored states so as to drive the first energy gathering device 5 to operate in the restored state to obtain a steady power.

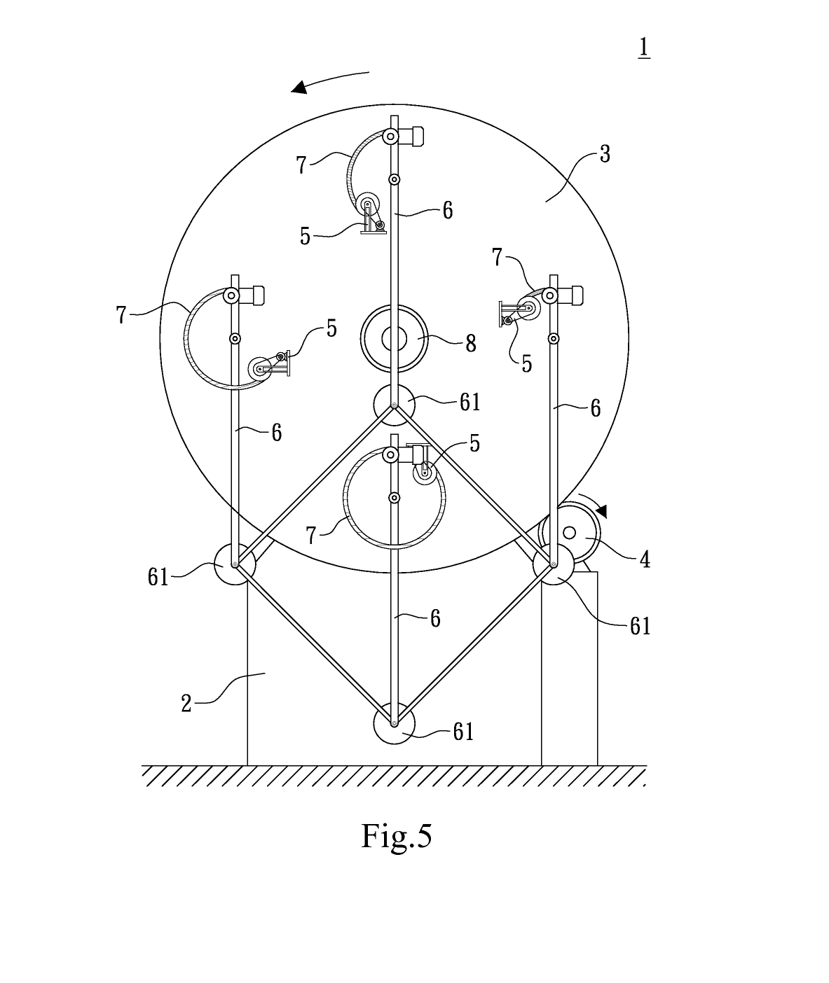

In addition, a second energy gathering device 8 is connected to the center of the rotary disk 3. It may also gather the energy when the rotary disk 3 rotates. Additionally, as depicted in FIG. 5, there may be a plurality of the poles 6 arranged and connected to the rotary disk 3, and the first heavy block 61 disposed at the end of every pole 6 may be interconnected to each other such that the pole 6 is kept vertically downwards.

The description referred to the drawings stated above is only for the preferred embodiments of the present invention. Many equivalent local variations and modifications that related to the present invention and do not depart from the spirit of the present invention can still be made by those skilled in the field, and these variations and modifications should be regarded to fall into the scope defined by the appended claims.

According to what is disclosed above, the present invention can achieve the objects and provide a power generating apparatus with simple structure, easy operation and low cost. It is novel and can be put into industrial use.

What is claimed is:

1. A power generating apparatus, comprising:
a base;
a rotary disk pivotally connected to said base;
a driving piece connected to said rotary disk for controlling said rotary disk rotating;
a first energy gathering device disposed on said rotary disk; and
a pole pivotally connected to said rotary disk, wherein an end of said pole is extended beyond the center of said rotary disk and a first heavy block is disposed at said end of said pole; an elastic piece is connected respectively to a front end of said pole and said first energy gathering device such that when said rotary disk rotates, said pole is kept vertically downwards because of gravity and said elastic piece is stretched because of the rotation of said rotary disk; while said pole moves with said rotary disk to a certain angle, said elastic piece is restored, so as to drive said first energy gathering device to operate to gather energy.

2. The power generating apparatus according to claim 1, wherein said driving piece is a motor.

3. The power generating apparatus according to claim 1, wherein said front end of said pole is provided with a motor and said elastic piece is connected respectively to said motor and said first energy gathering device.

4. The power generating apparatus according to claim 1, wherein a second heavy block is disposed at an opposite end of said rotary disk with respect to the position where said pole is connected to.

5. The power generating apparatus according to claim 1, wherein said elastic piece is a spring.

6. The power generating apparatus according to claim 1, wherein a second energy gathering device is connected to the center of said rotary disk.
